(19) United States
(12) Patent Application Publication
(10) Pub. No.: US 2025/0060510 A1
(43) Pub. Date: Feb. 20, 2025

(54) METHOD FOR 4D KINEMATIC MODELING OF SUBMARINE SALT LAYER

(71) Applicant: PETRÓLEO BRASILEIRO S.A. – PETROBRAS, Rio de Janeiro (BR)

(72) Inventors: Pedro De Almeida Martins Das Neves MIRANDA, Rio de Janeiro (BR); Wagner Nahas RIBEIRO, Rio de Janeiro (BR); Alexandre Antônio De Oliveira LOPES, Rio de Janeiro (BR)

(21) Appl. No.: 18/747,868

(22) Filed: Jun. 19, 2024

(30) Foreign Application Priority Data
Aug. 18, 2023 (BR) 1020230166962

(51) Int. Cl. G01V 20/00; G06F 17/11

(52) U.S. Cl. CPC G01V 20/00; G06F 17/11

(57) ABSTRACT

The present disclosure discloses embodiments of a kinematic modeling method and computer readable non-transitory storage medium for predicting the evolution of a submarine salt sedimentary layer. An embodiment of a method includes the steps of: generating a reference map for the layer thickness in the analyzed geological event; determining reference geometry for the base surface of the layer in the analyzed geological event; determining geometry of the top surface of the layer in the analyzed geological event; and calculating the positioning of the top surfaces and adjustment of the global volume of the layer.

### FIELD OF THE DISCLOSURE

The present disclosure pertains to the field of oil exploration. More specifically, the present disclosure relates to kinematic modeling methods for predicting the evolution of submarine sedimentary layers, particularly salt layers.

### Backgrounds of the Disclosure

The study of the evolution of the salt layer over geological time is an essential element for evaluating prospects during the exploratory phase. Due to the sealing characteristic of the salt layer, the quality of the modeling result (part of the scope of oil system modeling, OSM), is crucial for predicting the filling history and volume of Pre-Salt accumulations. In the context of OSM, the traditionally applied solution is based only on the back-stripping technique, whose premise is that displacements occur predominantly in one direction (vertical) caused by the burial and compaction processes. This strategy is considered efficient for most sedimentary materials, but salt is an exception. Due to its rheological characteristics, the geometric evolution of the salt layer over geological time is significantly affected by lateral transport processes (examples: formation of structures such as diapirs, salt tongues, among others), something that the back-stripping technique is not able to simulate. Thus, 4D simulation/modeling of the salt layer represents a technological challenge for the OSM area.

### STATE OF THE ART

The publication “Salt tectonics driven by differential sediment loading: stability analysis and finite-element experiments”, L. Gemmer et al., Basin Research (2004) 16, 199-218, discloses 2D finite element modeling techniques for investigate systems in which a linear viscous salt layer underlies a frictional plastic overburden of laterally varying thickness. In these systems, the differential pressure induces viscous salt flow, and the overburden experiences upward deviatoric stress and downward compression. A thin-sheet analytical stability criterion for the system is derived and is used to predict the conditions under which the sediment cover will be unstable and fail, and to estimate the initial speeds of the system. It also discloses that the numerical model is used to investigate the subsequent finite deformation. As the systems evolve, overburden extension and salt diapirism occur in the landward section and contractional structures develop in the seaward section. The system evolution depends on the relative widths of the salt basin and the length scale of the overburden thickness variation. In narrow salt basins, overburden deformation is localized and characterized by high strain rates, which cause the system to reach a gravitational equilibrium and salt movement to cease earlier than for wide salt basins. Sedimentation enhances salt evacuation by maintaining a differential pressure in the salt. Continued sedimentary filling of landward extensional basins suppresses landward salt diapirism. Sediment progradation leads to seaward propagation of the landward extensional structures and depocentres. At slow sediment progradation rates, the viscous flow can be faster than the sediment progradation, leading to efficient salt evacuation and salt weld formation beneath the landward section. Fast sediment progradation suppresses the viscous flow, leaving salt pillows beneath the prograding wedge.

Patent EP2629123 B1, entitled “Simulation model optimization”, discloses a method that includes the steps of: providing a finite element grid described with respect to a lateral coordinate axis and a depth coordinate axis to model a multilayer sedimentary basin (510); coarsening the finite element grid with respect to the lateral coordinate axis to provide a coarsened finite element grid (520); performing a back-stripping and forward simulation cycle using the coarsened finite element grid to provide geometry and porosity results for the multilayer sedimentary basin model (530); refining the finite element grid with respect to the lateral coordinate axis to provide a refined finite element grid (540); and performing the back-stripping and forward simulation cycle using the refined finite element grid and at least porosity results to provide improved geometry and porosity results for the multilayer sedimentary basin model (550). It also teaches about horizontal movement of sediment layers, including salt, in paragraph 64: “As an example, horizontal movements of layers like salt may be described with addition of thickness maps, for example, during doming. Such changes may be realized by layer stretching and thinning. As an example, one or more salt maps may be provided for various geologic events (e.g., based on kinematic models) that may be taken into consideration during a cycle. Where salt domes, salt pillows, etc., are modeled, high overburden may result in reverse structures. Various techniques may be applied, for example, to handle salt intrusions, for example, into one or more overburden layers.”

The international publication WO0247011A1, entitled “Methods for modeling multi-dimensional domains using information theory to resolve gaps in data and in theories”, discloses methods for modeling multi-dimensional domains by merging multiple input data sets into one model, applying multiple theories dynamics to evolve the model and using information theory to resolve gaps and discrepancies between data sets and theories. It discloses, in paragraph 12: “One embodiment of the disclosure is a 3-D geologic basin simulator that integrates seismic inversion techniques with other data to predict fracture location and characteristics. The 3-D finite-element basin reaction, transport, mechanical simulator includes a rock rheology that integrates continuous poroelastic/viscoplastic, pressure solutions deformation with brittle deformation (fracturing, failure). Mechanical processes are used to coevolve deformation with multi-phase flow, petroleum generation, mineral reactions, and heat transfer to predict the location and producibility of fracture sweet spots. Information theory uses the geologic basin simulator predictions to integrate well log, surface, and core data with the otherwise incomplete seismic data. The geologic simulator delineates the effects of regional tectonics, petroleum-derived overpressure, and salt tectonics and constructs maps of highgrading zones of fracture producibility.” This document of prior art also discloses the use of software called Basin RTM to run the simulations, being capable of simulating movement of salt layers (paragraphs 73-75, 117).

### SUMMARY OF THE DISCLOSURE

The present disclosure discloses a new methodology for predicting and modeling the movement of a submarine salt sedimentary layer, called 4D Kinematic Modeling.

The main inputs of the methodology disclosed herein are the geometric information (thickness and top and base surfaces) of the submarine salt layer in two configurations: initial (moment of the salt deposition in the sedimentary basin) and final (present time). These data are the basis for determining all intermediate layer configurations, i.e., geological ages/events between the deposition and the present time.

The first step of the method consists of generating a reference map for the layer thickness in the analyzed geological event. For each (x,y) position of the model, a reference thickness (e_{ref}) is calculated. This map is important for representing structures such as salt diapirs or windows (areas where a contact is formed between pre-salt and post-salt strata due to the reduction in the thickness of the salt layer). The second step of the method consists of determining the reference geometry of the base surface of the layer in the analyzed geological event, as a transition between the initial configuration (moment of deposition) and the final configuration (present time). This procedure is essential to guarantee the consistency of the structures observed at the base of the layer, with a direct impact on the volume prediction and filling history of the pre-salt accumulations. In the third step, the configuration of the top surface of the layer for the analyzed event is defined through back-stripping [Perrier and Quiblier (1974), Watts and Ryan (1976)], a technique traditionally applied in modeling oil systems. The last step of the methodology performs the positioning of the top and base surfaces of the layer focusing on adjusting the global volume of the layer. These phenomena are represented by a global reference volume (V_{ref}), which is specific to the geological event by the modeler. The objective is to allow the simulation of relevant scenarios in modeling oil systems, in which there is variation in the volume of the layer over time, such as: dissolution of salt in an aqueous medium, formation of allochthonous bodies or input/output of salt in the modeled region due to lateral movement of the material (generally in scenarios where the modeled area is a section of the basin and does not encompass the entire salt layer).

### BRIEF DESCRIPTION OF THE DRAWINGS

The present disclosure will now be described below with reference to the typical embodiments thereof and also with reference to the attached drawings, in which:

FIG. 1 is a representation of a flowchart of the method according to the present disclosure; and

FIGS. 2 and 3 are representations of comparisons between the evolution of the salt layer according to the prior art and according to the present disclosure.

### DETAILED DESCRIPTION OF THE DISCLOSURE

Specific embodiments of the present disclosure are described below. In an effort to provide a concise description of these embodiments, all features of an actual implementation may not be described in the specification. It should be appreciated that, in the development of any actual implementation, as in any engineering or design project, numerous implementation-specific decisions must be made to achieve the specific objectives of the developers, such as compliance with system and business related constraints, which may vary from one implementation to another. Furthermore, it should be appreciated that such a development effort may be complex and time-consuming, but would nevertheless be a routine design and manufacturing undertaking for those of ordinary skill having the benefit of this disclosure.

In a main embodiment, the present disclosure discloses a new methodology for predicting and modeling the movement of a submarine salt sedimentary layer, called 4D Kinematic Modeling. This is a solution applied in oil system computational modeling to determine the geometry of the salt layer at any geological age/event during the evolution of the sedimentary basin. Below, the sequence of procedures that make up the methodology is described, as well as the information necessary for its execution.

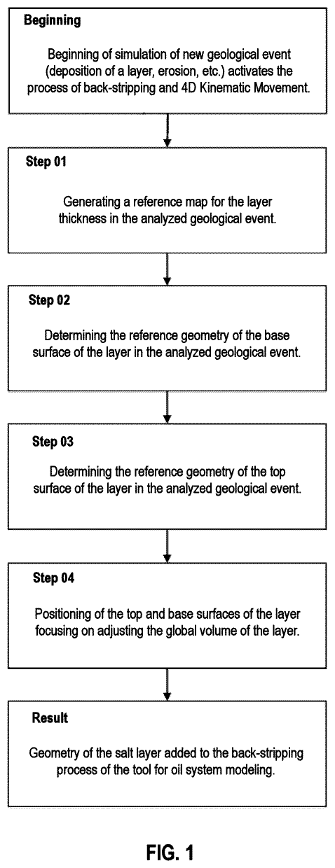

The main inputs of the 4D Kinematic Modeling are the geometric information (thickness and top and base surfaces) of the layer in two configurations: initial (moment of the salt deposition in the sedimentary basin) and final (present time). These data are the basis for determining all intermediate configurations (i.e. geological ages/events between the deposition and present time) of the layer. The steps of the method according to the main embodiment of the present disclosure will be described below with reference to FIG. 1.

The first step of the method consists of generating a reference map for the layer thickness in the analyzed geological event. This map is important for representing structures such as salt diapirs or windows (areas where a contact is formed between pre-salt and post-salt strata due to the reduction in the thickness of the salt layer). For each (x,y) position of the model, the reference thickness (e_{ref}) is calculated according to equation [1]:

$${e}_{ref} = {e}_{i} ( 1 - {T}_{m} ) + {e}_{f} {T}_{m} \qquad [ 1 ]$$

Wherein eᵢ and e_{f} correspond to the thicknesses at (x,y) position measured, respectively, in the initial configuration and final configuration of the layer. There are several ways known in the art to measure or estimate the initial and final thicknesses of each x,y position. By way of example and without limitation, final (present time) thicknesses can be obtained empirically by ultrasonic scanning of submarine soil. By way of example and without limitation, the initial thicknesses can be estimated assuming that the volume of salt at deposition is around 10% to 15% greater than the final volume. Alternatively, the volume can be estimated using an average thickness evaluated in a section of the modeled area wherein the salt has deformed little. Furthermore, the shape of the surfaces during deposition can be estimated because there are typical features of the depositional environment of this material: its top surface is approximately flat and the shape of the base surface is close to the final one (since the salt is deposited after the end of rift phase).

Tₘ (called movement rate) is the parameter that controls the speed of formation of diapirs, domes and windows. Its value reflects the accumulated movement of the layer since its deposition, varying in the range of 0% (resting state and equivalent to the initial configuration) to 100% (when structures and salt windows are already formed and stabilized and the halo-kinetic activity ceases). It should be noted that the Tₘ parameter is arbitrated according to the modeler's assessment of the depositional processes and the geological context of the analyzed area. In general, the values of the Tₘ parameter are estimated as a function of the sediment deposition rate of each event: the higher the sedimentation rate, the greater the advance of movement. However, other ways known in the art of estimating the values of the Tₘ parameter are possible without departing from the scope of the present disclosure.

The second step of the method consists of determining the reference geometry of the base surface of the layer in the analyzed geological event. This procedure is essential to guarantee the consistency of the structures observed at the base of the layer, with a direct impact on the volume prediction and filling history of the pre-salt accumulations. The step begins by defining the time interval in which the transition between the initial configuration (moment of deposition) and the final configuration (present time) occurs. It is considered that the deposition age of the layer marks the beginning of the interval, whereas the end of the transition (t_{ft}) is determined by equation [2]:

$${t}_{ft} = {t}_{i} + ( {t}_{f} - {t}_{i} ) ( 1 - v ) \qquad [ 2 ]$$

Wherein tᵢ and t_{f} represent, respectively, the age of layer deposition and the present time in millions of years (My). In this case, as the present time is being considered, it will be equal to zero; however, it is possible to consider other points in time in other applications. The variable v (called transition speed) is a parameter that controls the speed of the transition, varying in the range from 0% to 100%. The higher the value assigned to v, the more accelerated the transition to the final configuration geometry. It is worth noting that the v parameter is arbitrated according to the modeler's assessment of the depositional processes and the geological context of the analyzed area. Advantageously, the flexible nature of this parameter allows the modeler to run scenarios or tests to understand the impact of the formation process of these structures on filling the fields.

Then, the transition factor (Fₜᵣ) can be calculated by introducing the age of the analyzed geological event (t) into equation [3]:

$${F}_{tr} = ( t - {t}_{i} ) / ( {t}_{ft} - {t}_{i} ) \qquad [ 3 ]$$

The step concludes with the calculation of the reference geometry of the base of the layer, wherein the reference depth (z_{ref}) for each (x,y) position of the surface is given by equation [4]:

$${z}_{ref} = {z}_{i} ( 1 - {F}_{tr} ) + {z}_{f} {F}_{tr} \qquad [ 4 ]$$

Wherein zᵢ and z_{f} represent the depth, in meters, of the base surface at (x,y) position in the initial configuration and final configuration, respectively.

In the third step, the configuration of the top surface of the layer for the analyzed event is defined through back-stripping [Perrier and Quiblier (1974), Watts and Ryan (1976)], a technique traditionally applied in modeling oil systems. Thus, for each (x,y) position, the depth of the top surface (zₜₒₚ) is given by subtracting the paleobathymetry by the compacted thickness of sedimentary material already deposited up to the analyzed age, according to equation [5]:

$${z}_{top} = {z}_{bat} - {e}_{sed} \qquad [ 5 ]$$

Wherein z_{bat} refers to paleobathymetry at (x,y) position and e_{sed} is equivalent to the compacted thickness of sediments above the top surface of the layer obtained through the back-stripping technique [Perrier and Quiblier (1974), Watts and Ryan (1976)]. The relevant parameters for back-stripping, such as lithological properties (density, compaction curve) and paleobathymetry maps are arbitrated according to the modeler's assessment of the depositional processes and the geological context of the analyzed area. There are several known techniques for estimating paleobathymetry based on biostratigraphy, structural analysis, knowledge of the depositional environment. The modeler may choose any of them without departing from the scope of the present disclosure.

The last step of the methodology performs the positioning of the top (geometry defined by eq. [5]) and the base (geometry defined by eq. [4]) surfaces of the layer focusing on adjusting the global volume of the layer. The objective is to allow the simulation of relevant scenarios in modeling oil systems, wherein there is variation in the volume of the layer over time, such as: dissolution of salt in an aqueous medium, formation of allochthonous bodies or input/output of salt in the modeled region due to lateral movement of the material (generally in scenarios where the modeled area is a section of the basin and does not encompass the entire salt layer). These phenomena are represented by a global reference volume (V_{ref}), which is specific to the geological event analyzed and defined according to equation [6]:

$${V}_{ref} = {V}_{f} {T}_{vv} \qquad [ 6 ]$$

Wherein V_{f} represents the volume of the layer at present time and Tᵥᵥ (called volume variation rate) is the parameter that establishes the relation between the two mentioned volumes. It should be noted that Tᵥᵥ is arbitrated according to the modeler's assessment of depositional processes and the geological context of the analyzed area. Commonly in the technique, it is estimated that the volume of deposited salt is between 10% and 15% greater than the volume at present time and is gradually reduced by dissolution until reaching the current volume. However, the modeler may adopt a different rate without departing from the scope of the present disclosure.

As the volume of the layer is equivalent to the space between the top surface and the base surface (calculated numerically by subtracting the depth of the two surfaces), it is necessary to adjust the distance between them so that the geometrically calculated volume is equal to the global volume reference (V_{ref}).

To achieve this, the method performs a translation with magnitude dz of the base surface, while the top surface is kept fixed, until the target (V_{ref}) is reached. At the same time, it is necessary to apply restrictions that guarantee geological coherence regarding the formation of structures and windows in the salt layer through the reference thicknesses calculated by equation [1]. That said, the final depth of each (x,y) position of the base surface (z_{base}) is determined by the system of equations [7]:

$$\{ \begin{matrix}{z}_{base} = {z}_{ref} + dz \\ If {e}_{ref} < {e}_{lim} , {z}_{base} = {z}_{top} - {e}_{ref} \\ If ( {z}_{top} - {z}_{base} ) < {e}_{ref} ( 1 - {T}_{corr} ) , {z}_{base} = {z}_{top} - {e}_{ref} ( 1 - {T}_{corr} )\end{matrix} \qquad [ 7 ]$$

The first criterion refers to the windows in the layer, and eₗᵢₘ (called window thickness) represents the limit thickness for opening windows. An e_{ref} smaller than eₗᵢₘ configures the opening of a window at the analyzed (x,y) position. The second criterion has the function of preventing the mischaracterization of structures (diapirs, domes) through the preservation of e_{ref}. In this case, T_{corr} (called thickness correction level) is the parameter that controls the flexibility of the algorithm to modify the e_{ref} value with the translation of the base surface. This parameter varies in the range from 0% to 100%, and the lower the value, the less flexibility the algorithm has to vary the layer thickness in relation to e_{ref}. It is worth noting that eₗᵢₘ and T_{corr} are arbitrated according to the modeler's assessment of depositional processes and the geological context of the analyzed area. Both eₗᵢₘ and T_{corr} are empirical parameters created to refine the final result. The initial value of each of them is free and, if the modeler understands that the result achieved is not satisfactory (that is, it presents geological inconsistencies), the modeler can test new values of both to try to make the response more geological.

At this point, the 4D Kinematic Movement processing ends, and the modeling products, that is, depth maps of the top and base surfaces of the layer for each geological event, are inserted into the computational tools as an element of the simulation of oil systems.

In summary, the input data for 4D Kinematic Movement modeling are:
Initial and final configuration of the salt layer: geometry of the top and base surfaces of the layer at the age of deposition of the salt layer and at the present time;
Movement rate (Tₘ): controls the speed of formation of diapirs, domes and windows. It varies in the range of 0% to 100% and its value is specific for each modeled geological event;
Transition speed (v): controls the speed at which the base surface transforms from the initial configuration to the final configuration. It varies in the range of 0% to 100% and its value is unique for the layer;
Volume variation rate (Tᵥᵥ): establishes the relation between the volume in the modeled event and the volume of the layer in its final configuration. Its value is specific to each modeled geological event;
Window thickness (eₗᵢₘ): limit thickness for opening windows in the layer. It uses metric units (m) and its value is unique for the layer;
Thickness correction level (T_{corr}): controls the flexibility of the algorithm to modify the e_{ref} value with the translation of the base surface. It varies in the range of 0% to 100% and its value is unique for the layer;
Computational model of the area/field: conventional model of oil system simulators from which there are extracted information such as paleobathymetry, ages and stratigraphic horizons, spatial facies distribution maps, compaction curves and other data that are not specific to the methodology of 4D Kinematic Movement of the Salt Layer.

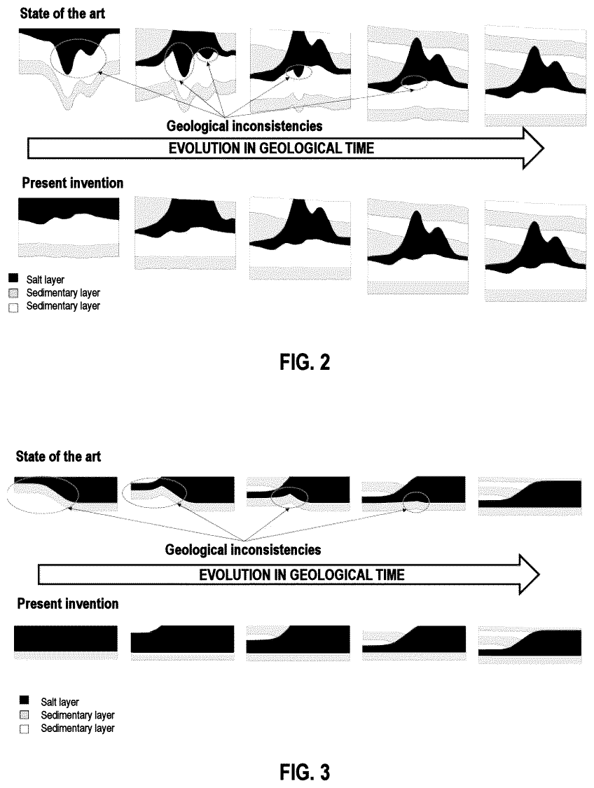

FIGS. 2 and 3 represent synthetic examples illustrating the advantages of the method described herein. In FIG. 2, the evolution of the formation of a salt diapir is exemplified, whereas in FIG. 3 the evolution of a thrust movement in the salt layer is exemplified. In the upper part of both these figures, the evolution according to the prior art is illustrated, whereas in the lower part the same evolution is exemplified using the method of the present disclosure. As can be seen, the previous technique cannot accurately model the salt layer, resulting in several geological inconsistencies.

In a further embodiment of the present disclosure, a computer-readable non-transitory medium is provided. The medium may be, for example, a memory, a flash memory, a hard disk, a compact disk, or any other device capable of storing computer instructions. When the readable medium of the present embodiment is read by a computer, the computer is enabled to perform the 4D Kinematic Movement method as previously described.

Although aspects of the present disclosure may be susceptible to various modifications and alternative forms, specific embodiments have been shown by way of example in the drawings and have been described in detail in this document. But it should be understood that the disclosure is not intended to be limited to the particular forms disclosed. Instead, the disclosure must encompass all modifications, equivalents and alternatives that fall within the scope of the disclosure as defined by the attached appended claims.

1. A kinematic modeling method to predict the evolution of a submarine salt sedimentary layer, the method comprising:
generating a reference map for the layer thickness in the analyzed geological event;
determining reference geometry for the base surface of the layer in the analyzed geological event;
determining geometry of the top surface of the layer in the analyzed geological event; and
calculating the positioning of the top surfaces and adjustment of the global volume of the layer.

2. The method according to claim 1, wherein the generating a reference map comprises determining a reference thickness (e_{ref}) calculated according to equation [1]:
$${e}_{ref} = {e}_{i} ( 1 - {T}_{m} ) + {e}_{f} {T}_{m} \qquad [ 1 ]$$
wherein eᵢ and e_{f} correspond to thicknesses measured, respectively, in the initial configuration and final configuration of a sedimentary layer, and wherein Tₘ is a movement rate that controls speed of formation of diapirs, domes and windows in the sedimentary layer.

3. The method according to claim 2, wherein the determining reference geometry comprises:
defining in which time interval a transition between an initial configuration and a final configuration of the sedimentary layer occurs, and wherein the age of deposition of the sedimentary layer is a beginning of the time interval and an end of a transition (t_{ft}) is determined by the equation [2]:
$${t}_{ft} = {t}_{i} + ( {t}_{f} - {t}_{i} ) ( 1 - v ) \qquad [ 2 ]$$
wherein tᵢ and t_{f} are, respectively, age of a layer deposition and present time, and v is transition speed;
calculating a transition factor (Fₜᵣ) by use of equation [3]:
$${F}_{tr} = ( t - {t}_{i} ) / ( {t}_{ft} - {t}_{i} ) , \qquad [ 3 ]$$
and calculating a reference depth (z_{ref}) for each (x,y) position of a surface by use of equation [4]:
$${z}_{ref} = {z}_{i} ( 1 - {F}_{tr} ) + {z}_{f} {F}_{tr} \qquad [ 4 ]$$
wherein zᵢ and z_{f} are, respectively, depth of a base surface of the sedimentary layer at (x,y) position in the initial configuration and in the final configuration.

4. The method according to claim 3, wherein the determining the geometry of the top surface comprises:
defining the configuration of the top surface of the sedimentary layer for the analyzed geological event, wherein, for each (x,y) position, the depth of the top surface (zₜₒₚ) is calculated according to equation [5]:
$${z}_{top} = {z}_{bat} - {e}_{sed} \qquad [ 5 ]$$
wherein z_{bat} is a paleobathymetry at (x,y) position and e_{sed} is a compacted thickness of sedimentary material above the top surface of the sedimentary layer, wherein e_{sed} is obtained through a back-stripping technique.

5. The method according to claim 4, wherein the calculating the positioning of the top surfaces and adjustment of the global volume of the layer comprises:
calculating a global reference volume (V_{ref}) specific to the geological event analyzed according to equation [6]:
$${V}_{ref} = {V}_{f} {T}_{vv} \qquad [ 6 ]$$
wherein V_{f} is the volume of the layer at present time, Tᵥᵥ is a rate of change in volume, and
calculating the final depth of each (x,y) position of the base surface (z_{base}) using a system of equations [7]
$$\{ \begin{matrix}{z}_{base} = {z}_{ref} + dz \\ If {e}_{ref} < {e}_{lim} , {z}_{base} = {z}_{top} - {e}_{ref} \\ If ( {z}_{top} - {z}_{base} ) < {e}_{ref} ( 1 - {T}_{corr} ) , {z}_{base} = {z}_{top} - {e}_{ref} ( 1 - {T}_{corr} )\end{matrix} \qquad [ 7 ]$$
wherein dz is magnitude of a translation of the base surface keeping the top surface fixed until V_{ref} is reached, eₗᵢₘ is a window thickness, and T_{corr} is a thickness correction level.

6. A computer-readable non-transitory storage medium comprising: instructions stored in computer-readable non-transitory storage medium, when read by a computer, to cause the computer to perform the following steps of:
generating a reference map for the layer thickness in the analyzed geological event;
determining reference geometry for the base surface of the layer in the analyzed geological event;
determining geometry of the top surface of the layer in the analyzed geological event; and
calculating the positioning of the top surfaces and adjustment of the global volume of the layer.
